(19) United States
(12) Patent Application Publication
(10) Pub. No.: US 2026/0343463 A1
(43) Pub. Date: Oct. 29, 2026

(54) ACCESS METHOD FOR NON-TERRESTRIAL NETWORK, AND APPARATUS

(71) Applicant: Beijing Xiaomi Mobile Software Co., Ltd., Beijing (CN)

(72) Inventor: Yuxin MAO, Beijing (CN)

(73) Assignee: Beijing Xiaomi Mobile Software Co., Ltd., Beijing (CN)

(21) Appl. No.: 19/119,586

(22) PCT Filed: Oct. 10, 2022
(86) PCT No.: PCT/CN2022/124460

§ 371 Date: Apr. 9, 2025

(51) Int. Cl. H04W 60/04; H04W 64/00; H04W 84/06

(52) U.S. Cl. CPC H04W 60/04; H04W 64/00; H04W 84/06

(57) ABSTRACT

An access method for a non-terrestrial network (NTN), and an apparatus, which method and apparatus can be applied to the technical field of communications. The method, which is executed by a first AMF, comprises: receiving a first request, which is sent by a terminal device and used for registering to an NTN, wherein the first request comprises first position information of the terminal device and first indication information, and the first indication information is used for indicating whether the terminal device supports access to a terrestrial network (TN); determining an NTN registration result according to the first indication information, the first position information, etc. ; and sending the NTN registration result to the terminal device. Therefore, it is ensured that an NTN registration result is determined on the basis of reliable position information, thereby improving the reliability and security of an NTN.

### CROSS REFERENCE TO RELATED APPLICATIONS

This application is a US National Phase of a PCT Application No. PCT/CN2022/124460 filed on Oct. 10, 2022, the entire contents of which are incorporated herein by reference in their entireties.

### TECHNICAL FIELD

The present disclosure relates to the field of communication technology, particularly to methods and apparatuses for accessing non-terrestrial networks.

### BACKGROUND

Relevant communication systems have been enhanced to support the service requirements of core networks with satellite access capabilities. When a terminal device uses satellite access, to ensure compliance with regulatory requirements, the network will verify whether the Public Land Mobile Network (PLMN) currently selected by the terminal device is allowed to operate in the country or region where the terminal device is located based on the location information of the terminal device.

### SUMMARY

The embodiments of the present disclosure provide methods and apparatuses for accessing non-terrestrial networks.

In the first aspect, the embodiments of the present disclosure provide a method for accessing a non-terrestrial network, performed by a first AMF and including:
receiving a first request for registering with a non-terrestrial network (NTN) transmitted by a terminal device, where the first request includes first indication information and first location information of the terminal device, and the first indication information is configured to indicate whether the terminal device supports terrestrial network (TN) access;
determining an NTN registration result; and
transmitting the NTN registration result to the terminal device.

In the present disclosure, after receiving the first request transmitted by the terminal device, the first AMF first determines the NTN registration result based on the first location information and first indication information in the first request, and then transmits the NTN registration result to the terminal device. Thus, it is ensured that the NTN registration result is determined based on reliable location information, improving the reliability and security of the NTN.

In the second aspect, the embodiments of the present disclosure provide a method for accessing a non-terrestrial network, performed by a terminal device and including:
transmitting a first request for registering with a non-terrestrial network (NTN) to a first access and mobility management function (AMF) network element, where the first request includes first indication information and first location information of the terminal device, and the first indication information is configured to indicate whether the terminal device supports terrestrial network (TN) access; and
receiving an NTN registration result transmitted by the first AMF network element.

In the third aspect, the embodiments of the present disclosure provide a communication device including:
a transceiver module, configured to receive a first request for registering with a non-terrestrial network (NTN) transmitted by a terminal device, where the first request includes first indication information and first location information of the terminal device, and the first indication information is configured to indicate whether the terminal device supports terrestrial network (TN) access; and
a processing module, configured to determine an NTN registration result;
where the transceiver module is further configured to transmit the NTN registration result to the terminal device.

In the fourth aspect, the embodiments of the present disclosure provide a communication device including:
a transceiver module, configured to transmit a first request for registering with a non-terrestrial network (NTN) to a first access and mobility management function (AMF) network element, where the first request includes first indication information and first location information of the terminal device, and the first indication information is configured to indicate whether the terminal device supports terrestrial network (TN) access;
where the transceiver module is further configured to receive an NTN registration result transmitted by the first AMF network element.

In a fifth aspect, the embodiments of the present disclosure provide a communication device including one or more processors, where when the one or more processors call a computer program stored in one or more memories, the method described in the first aspect is executed.

In a sixth aspect, the embodiments of the present disclosure provide a communication device including one or more processors, where when the one or more processors call a computer program stored in one or more memories, the method described in the second aspect is executed.

In a seventh aspect, the embodiments of the present disclosure provide a communication device, including one or more processors and one or more memories, where a computer program is stored in the one or more memories, and the one or more processors execute the computer program stored in the one or more memories to enable the communication device to execute the method described in the first aspect.

In an eighth aspect, the embodiments of the present disclosure provide a communication device, including one or more processors and one or more memories, where a computer program is stored in the one or more memories, and the one or more processors execute the computer program stored in the one or more memories to enable the communication device to execute the method described in the second aspect.

In a ninth aspect, the embodiments of the present disclosure provide a communication device, including one or more processors and an interface circuit; where the interface circuit is configured to receive code instructions and transmit the code instructions to the one or more processors; and the one or more processors are used to run the code instructions to execute the method described in the first aspect.

In a tenth aspect, the embodiments of the present disclosure provide a communication device, including one or more processors and an interface circuit; where the interface circuit is configured to receive code instructions and transmit the code instructions to the one or more processors; and the one or more processors are used to run the code instructions to execute the method described in the second aspect.

In an eleventh aspect, the embodiments of the present disclosure provide a communication system including the communication device as described in the third aspect and the communication device as described in the fourth aspect, or including the communication device as described in the fifth aspect and the communication device as described in the sixth aspect, or including the communication device as described in the seventh aspect and the communication device as described in the eighth aspect, or including the communication device as described in the ninth aspect and the communication device as described in the tenth aspect.

In a twelfth aspect, the embodiments of the present disclosure provide a computer-readable storage medium storing instructions used by the terminal device, where when the instructions are performed, the terminal device executes the method described in the first aspect.

In a thirteenth aspect, the embodiments of the present disclosure provide a computer-readable storage medium storing instructions used by the terminal device, where when the instructions are executed, the terminal device executes the method described in the second aspect.

In a fourteenth aspect, the present disclosure further provides a computer program product including a computer program, where when the computer program runs on a computer, the computer executes the method described in the first aspect.

In a fifteenth aspect, the present disclosure further provides a computer program product including a computer program, where when the computer program runs on a computer, the computer executes the method described in the second aspect. In a sixteenth aspect, the present disclosure provides a chip system including one or more processors and an interface to support the first AMF in implementing the functions involved in the first aspect, such as determining or processing at least one of data or information involved in the above method. In some embodiments, the chip system further includes one or more memories for storing a computer program and data necessary for the terminal device. The chip system can be composed of one or more chips or include one or more chips and other discrete devices.

In a seventeenth aspect, the present disclosure provides a chip system including one or more processors and an interface to support the terminal device in implementing the functions involved in the first aspect, such as determining or processing at least one of data or information involved in the above method. In some embodiments, the chip system further includes one or more memories for storing a computer program and data necessary for the terminal device. The chip system can be composed of one or more chips or include one or more chips and other discrete devices.

In the eighteenth aspect, the present disclosure provides a computer program, where when the computer program runs on a computer, the computer executes the method described in the first aspect.

In a nineteenth aspect, the present disclosure provides a computer program, where when the computer program runs on a computer, the computer executes the method described in the second aspect.

### BRIEF DESCRIPTION OF DRAWINGS

In order to provide a clearer explanation of technical solutions in the embodiments or background technology of the present disclosure, accompanying drawings used in the embodiments or background technology of the present disclosure will be explained below.

FIG. 1 is a schematic structural diagram of a communication system provided in the embodiments of the present disclosure.

FIG. 2 is a flowchart of a method for accessing a non-terrestrial network provided in the embodiments of the present disclosure.

FIG. 3 is a flowchart of another method for accessing a non-terrestrial network provided in the embodiments of the present disclosure.

FIG. 4 is a flowchart of another method for accessing a non-terrestrial network provided in the embodiments of the present disclosure.

FIG. 5 is a flowchart of another method for accessing a non-terrestrial network provided in the embodiments of the present disclosure.

FIG. 6 is a flowchart of another method for accessing a non-terrestrial network provided in the embodiments of the present disclosure.

FIG. 7A is a flowchart of a method for accessing a non-terrestrial network provided in the embodiments of the present disclosure.

FIG. 7B is a flowchart of a method for accessing a non-terrestrial network provided in the embodiments of the present disclosure.

FIG. 7C is a schematic interaction diagram of a method for accessing a non-terrestrial network provided in the embodiments of the present disclosure.

FIG. 8 is a schematic interaction diagram of a method for accessing a non-terrestrial network provided in the embodiments of the present disclosure.

FIG. 9 is a schematic interaction diagram of a method for accessing a non-terrestrial network provided in the embodiments of the present disclosure.

FIG. 10 is a schematic interaction diagram of another method for accessing a non-terrestrial network provided in the embodiments of the present disclosure.

FIG. 11 is a schematic structural diagram of a communication device provided in the embodiments of the present disclosure.

FIG. 12 is a schematic structural diagram of another communication device provided in the embodiments of the present disclosure.

FIG. 13 is a schematic structural diagram of a chip provided in the embodiments of the present disclosure.

### DETAILED DESCRIPTION

For ease of understanding, terms involved in the present disclosure are first explained below.

### 1. Public Land Mobile Network (PLMN)

PLMN is a network established and operated by the government or operators approved by the government for the purpose of providing land mobile communication services to the public. A terminal device usually needs to maintain several different types of PLMN lists, where each of the PLMN lists contains multiple PLMNs, such as the Registered PLMN (RPLMN) list, Home PLMN (HPLMN) list, Visited PLMN (VPLMN) list, and so on. Different types of PLMNs have different priorities. The terminal device can select a PLMN according to priority and report the selected PLMN to the network, e.g., transmitting the selected PLMN to an access network device or an access and mobility management function (AMF) network element in the core network.

### 2. Access and Mobility Management Function (AMF)

AMF is a logical node and a functional network element on the core network side, which serves as a core network control plane access point of the terminal and the radio access network, receives all connection and session related information from user equipment and performs registration, connection, reachability, and mobility management. In addition, AMF provides a transmission channel of session management messages for the terminal device and a session management function (SMF) device, as well as authentication and authorization functions for user access.

### 3. Location Management Function (LMF)

LMF manages the coordination and scheduling of overall resources required for the location of the terminal device registered or accessed the 5th Generation Mobile Communication technology (5G) core network, and calculates and authenticates a final location, performs speed estimation, and may estimate achievable accuracy. LMF obtains a location request for a target terminal device from AMF via the NImf interface. LMF interacts with the terminal device to exchange location information applicable to terminal device assisted and terminal device based positioning methods, and interacts with the next generation radio access network (NG-RAN) to obtain location information.

### 4. Unified Data Management (UDM)

UDM is responsible for managing terminal device identifier, subscription data, authentication data, and registration management of service network elements for the terminal device, such as AMF currently providing services to the terminal device, etc. For example, when a terminal device switches access to a new AMF, UDM will initiate a deregistration message to the old AMF, requesting the old AMF to delete user related information).

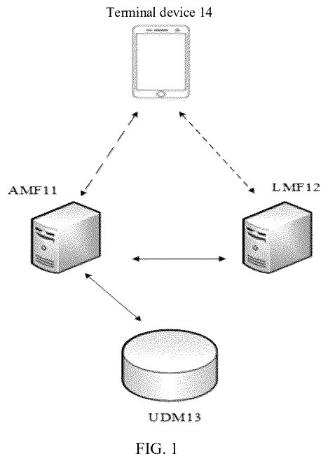

Referring to FIG. 1, FIG. 1 is a schematic structural diagram of a communication system according to embodiments of the present disclosure. The communication system may include but is not limited to one network device and one terminal device. The number and form of devices shown in FIG. 1 are only for example and do not constitute a limitation on the embodiments of the present disclosure. In practical applications, the communication system may include two or more network devices, or two or more terminal devices. The communication system shown in FIG. 1 takes one AMF11, one LMF12, one UDM13, and one terminal device 14 as an example.

It should be noted that the technical solution of the embodiments of the present disclosure can be applied to various communication systems, such as a long term evolution (LTE) system, a 5th generation (5G) mobile communication system, a 5G new radio (NR) system, or other future new mobile communication systems.

In some embodiments, the communication system may further include an access network device. Where the access network device is an entity for transmitting or receiving signals on the network side, such as an evolved NodeB (eNB), a transmission reception point (TRP), a next generation NodeB (gNB) in an NR system, a base station in other future mobile communication systems, or an access node in wireless fidelity (WiFi) systems. The embodiments of the present disclosure do not limit the specific technology or specific device form adopted by the network device. The network device provided in the embodiments of the present disclosure can be composed of a central unit (CU) and a distributed unit (DU), where the CU can also be referred to as a control unit. The network device (such as a protocol layer of the base station) can be separated by the CU-DU structure, where some functions of the protocol layer are distributed in the CU and centrally controlled, and a part of or all of the remaining functions of the protocol layer are distributed in the DU, where the CU centrally controls the DU.

The number of AMF11, LMF12, and UDM13 in the embodiments of the present disclosure can be one or more. They are different network function (NF) elements in the control plane of the 5G core network.

The terminal device 14 in the embodiments of the present disclosure is an entity for receiving or transmitting signals on the user side, such as a mobile phone. The terminal device can also be referred to as a terminal, a user equipment (UE), a mobile station (MS), or a mobile terminal (MT). The terminal device can include a car, a smart car, a mobile phone, a wearable device, a pad, a computer with a wireless transmission and reception capability, a virtual reality (VR) terminal device, an augmented reality (AR) terminal device, a wireless terminal device in industrial control, a wireless terminal device in self driving, a wireless terminal device in remote medical surgery, a wireless terminal device in smart grid, a wireless terminal device in transportation security, a wireless terminal device in smart city, or a wireless terminal device in smart home, that has a communication capability. The embodiments of the present disclosure do not limit the specific technology or specific device form adopted by the terminal device.

It can be understood that the communication system described in the embodiments of the present disclosure is intended to provide a clearer explanation of the technical solutions in the embodiments of the present disclosure, and does not constitute a limitation on the technical solutions provided in the embodiments of the present disclosure. As those skilled in the art know, with the evolution of the system architecture and the emergence of new business scenarios, the technical solutions provided in the embodiments of the present disclosure are also applicable to similar technical problems.

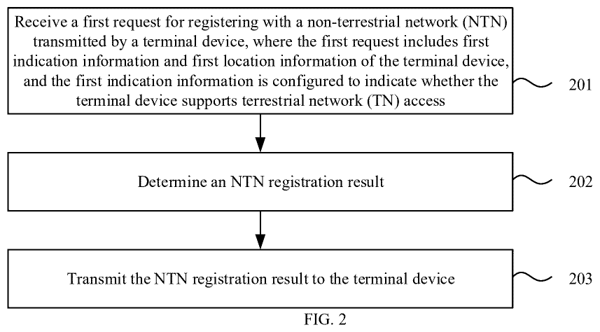

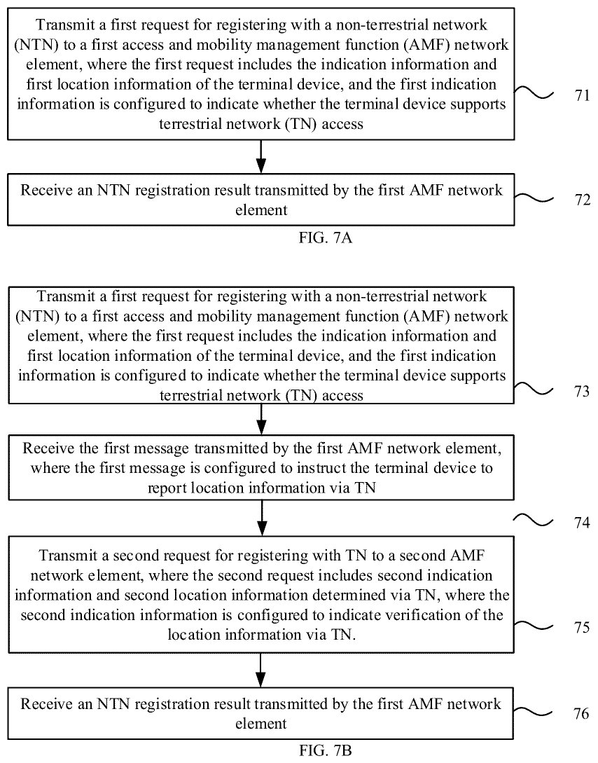

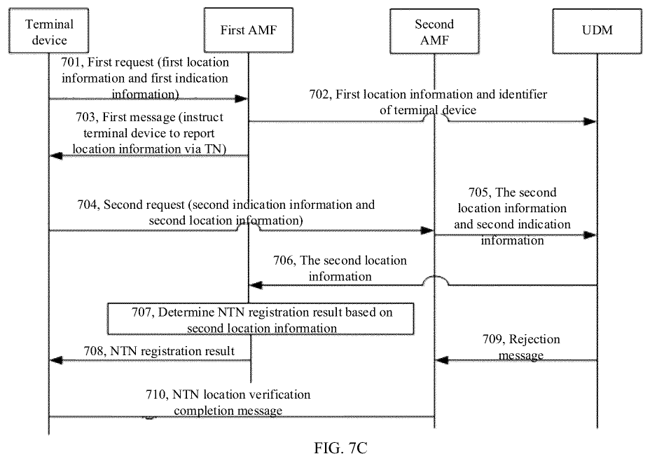

In this system, the AMF network element can implement the method shown in the embodiment of any one of FIGS. 2 to 6 of the present disclosure, and the terminal device can implement the method shown in the embodiment of any one of FIGS. 7A to 7B of the present disclosure.

It can be understood that the communication system described in the embodiments of the present disclosure is intended to provide a clearer explanation of the technical solutions in the embodiments of the present disclosure, and does not constitute a limitation on the technical solutions provided in the embodiments of the present disclosure. As those skilled in the art know, with the evolution of the system architecture and the emergence of new business scenarios, the technical solutions provided in the embodiments of the present disclosure are also applicable to similar technical problems.

When a terminal device uses satellite access, in order to ensure compliance with regulatory requirements, the network device need to verify whether the PLMN currently selected by the terminal device is allowed to operate in the country or region where the terminal device is located based on the location information of the terminal device. However, the location information generated by the terminal device when using satellite access, such as the location information generated when registering with the Global Navigation Satellite System (GNSS), may not be reliable. Therefore, the present disclosure proposes that when a terminal device accesses a non-terrestrial Network (NTN), the network device can verify the location information reported by the terminal device based on whether the terminal device supports Terrestrial Network (TN) access and the coverage of TN. Based on the verified location information, the registration result can be determined and then returned to the terminal device.

The following provides a detailed explanation of the method for accessing a non-terrestrial network provided in the embodiments of the present disclosure, based on various flowcharts.

Referring to FIG. 2, FIG. 2 is a flowchart of a method for accessing a non-terrestrial network provided in the embodiments of the present disclosure. The method provided in this embodiment can be performed by a first AMF network element. As shown in FIG. 2, the method may include but is not limited to the following steps 201 to 203.

In step 201, a first request for registering with a non-terrestrial network (NTN) transmitted by a terminal device is received, where the first request includes first indication information and first location information of the terminal device, and the first indication information is configured to indicate whether the terminal device supports terrestrial network (TN) access.

In some embodiments, the first request can be a reused NTN registration request in the related art, or a new NTN registration request, which is not limited by the present disclosure.

In some embodiments, the first location information (such as GNSS location information) is generated by the terminal device when using satellite access. The first indication information can be a specified field in the first request, where the specified field can have different values for indicating whether the terminal device supports TN access. For example, a value of this field being 1 indicates that the terminal device supports TN access, and a value of this field being 0 indicates that the terminal device does not support TN access. Alternatively, the first indication information can also be obtained through the designated information domain in the first request. The present disclosure does not limit this.

In some embodiments, the first request may further include other NTN registration parameters, such as registration type, subscription concealed identifier (SUCI), 5G Global Unique Temporary UE Identity (5G-GUTI), or security parameters, etc. The present disclosure does not limit this.

In some embodiments, the first request can be first transmitted by the terminal device to the NTN access network device, and then forwarded by the NTN access network device to the first AMF. The present disclosure does not limit this.

In step 202, an NTN registration result is determined.

In the present disclosure, after receiving the first request, the first AMF can first determine whether the terminal device supports TN access based on the first indication information. If the terminal device supports TN access and is within the coverage of TN, the terminal device can be triggered to report location information again via TN; and if the terminal device does not support TN access or is not within the coverage of TN, the terminal device can be repositioned via NTN to obtain new location information of the terminal device. Then, the first location information is verified based on the new location information obtained, and the NTN registration result is determined based on the verification result.

In some embodiments, the coverage of TN can be the information of TN prestored in the first AMF, which can be used to represent the areas that TN can cover.

In some embodiments, if a PLMN currently selected by the terminal device allows the terminal device to operate in the country or region to which verified location information of the terminal device belongs, the NTN registration result can be to accept network registration with the NTN; and alternatively, if a PLMN currently selected by the terminal device does not allow the terminal device to operate in the country or region to which verified location information of the terminal device belongs, the NTN registration result can be to reject network registration with the NTN.

In step 203, the NTN registration result is transmitted to the terminal device.

In some embodiments, the first AMF can transmit the NTN registration result to the terminal device through a registration response message (e.g., registration response).

In some embodiments, the first AMF can indicate the NTN registration result through a field in the registration response message, where different values of the field indicate different registration results.

In the present disclosure, after receiving the first request transmitted by the terminal device, the first AMF first determines the NTN registration result based on the first location information and first indication information in the first request, and then transmits the NTN registration result to the terminal device. Thus, it is ensured that the NTN registration result is determined based on reliable location information, improving the reliability and security of the NTN.

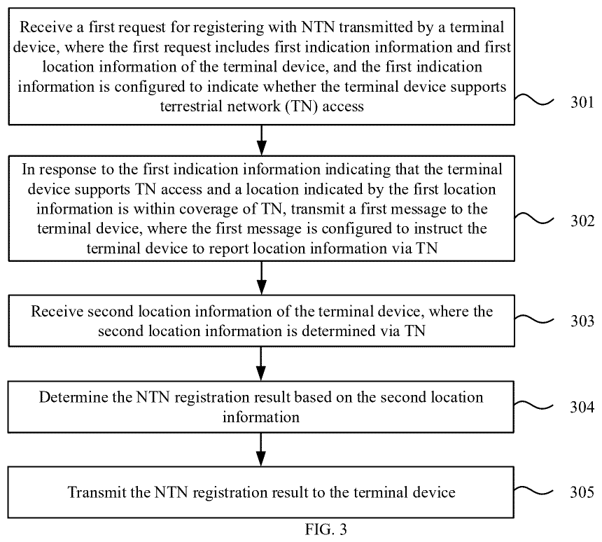

Referring to FIG. 3, FIG. 3 is a flowchart of another method for accessing a non-terrestrial network provided in the embodiments of the present disclosure. The method provided in this embodiment can be performed by a first AMF network element. As shown in FIG. 3, the method may include but is not limited to the following steps 301 to 305.

In step 301, a first request for registering with NTN transmitted by a terminal device is received, where the first request includes first indication information and first location information of the terminal device, and the first indication information is configured to indicate whether the terminal device supports terrestrial network (TN) access.

Where the specific implementation of step 301 can refer to the detailed description of any embodiment of the present disclosure, and will not be repeated here.

In step 302, in response to the first indication information indicating that the terminal device supports TN access and a location indicated by the first location information is within coverage of TN, a first message is transmitted to the terminal device, where the first message is configured to instruct the terminal device to report location information via TN.

In some embodiments, the first message can be a registration request confirmation message. The first AMF can directly trigger the terminal device to report location information via TN by transmitting the first message. For example, as long as the first AMF transmits the first message to the terminal device, the terminal device needs to report the location information via TN; and if the first AMF does not transmit the first message to the terminal device after receiving the first request, the terminal device does not need to report its location information via TN.

Alternatively, the first AMF can also indicate whether the terminal device needs to report location information via TN through a specified field or information domain in the first message. For example, if the value of the specified field or information domain in the first message is the first preset value, it indicates that the terminal device needs to report its location information via TN. If the value of the specified field or information domain in the first message is the second preset value, it indicates that the terminal device does not need to report its location information via TN. The present disclosure does not limit this.

In step 303, second location information of the terminal device is received, where the second location information is determined via TN.

In some embodiments, the second location information is the location information of the terminal device generated via TN, and can be transmitted by the unified data management (UDM) network element.

In some embodiments, the first AMF can receive the second location information transmitted by UDM through Nudm notification messages. For example, the first AMF can receive the second location information transmitted by UDM through the Nudm_SDM_notification message, which is not limited in the present disclosure.

In the present disclosure, after receiving the first message instructing the terminal device to report location information via TN from the first AMF, the terminal device can transmit a second request to the AMF for registration with TN to request verification of location information via TN. If the second AMF receiving the second request transmitted by the terminal device is different from the first AMF receiving the first request, the second AMF receiving the TN registration request can transmit the obtained second location information to the UDM, and the UDM can transmit the second location information to the first AMF receiving the first request.

In some embodiments, since the purpose of the second request is to verify the first location information through TN, in addition to the second location information, the second request may further include second indication information, where the second indication information is configured to indicate the verification of the location information through TN. Therefore, after receiving the second request, the second AMF can determine that the purpose of the request is to verify the location information of the terminal device, and then the second AMF can transmit the received second location information and second indication information to UDM.

In some embodiments, in order to ensure that UDM can accurately determine the AMF to which the second location information needs to be synchronized when receiving the second location information transmitted by the second AMF, the first AMF can further transmit the first location information and the identifier of the terminal device to UDM after receiving the first request. That is, the method further includes: transmitting a second message to the UDM network element, where the second message includes the first location information and an identifier of the terminal device.

In some embodiments, the second message can be a UE registration message, such as Nudm_UECM_Registration, which is not limited in the present disclosure.

In some embodiments, the second location information may be the same as or different from the first location information.

In an embodiment of the present disclosure, if the second location information is the same as the first location information, UDM can transmit the second location information to the first AMF, and the first AMF determines whether the first location information is reliable based on whether the second location information matches the first location information; or UDM may not transmit the second location information to the first AMF, and only transmit a confirmation indication of the first location information to indicate to the first AMF that the first location information is reliable.

Alternatively, the second location information can also be transmitted by the terminal device through a second request. That is, the first AMF can also receive a second request transmitted by the terminal device, where the second request includes second location information and second indication information. The second indication information is configured to indicate the verification of location information through TN.

In some embodiments, the second request can be transmitted by the terminal device to the first AMF through the TN access network device, which is not limited in the present disclosure.

That is, in the present disclosure, the second AMF that receives the second request and the first AMF that receives the first request can be the same, which means that when the terminal device accesses NTN and TN through the same AMF; or the second AMF that receives the second request may be different from the first AMF that receives the first request, which means that the terminal device accesses NTN and TN respectively through different AMFs, which is not limited in the present disclosure.

In step 304, the NTN registration result is determined based on the second location information.

In the present disclosure, after receiving the second location information, the first AMF can directly determine whether the PLMN currently selected by the terminal device allows to operate in the country or region to which the second location information belongs. If it is allowed to operate in the country or region where the second location information belongs, the NTN registration result can be to accept network registration with the NTN; alternatively, if a PLMN currently selected by the terminal device does not allow the terminal device to operate in the country or region to which the second location information belongs, the NTN registration result can be to reject network registration with the NTN.

In step 305, the NTN registration result is transmitted to the terminal device.

In the present disclosure, after receiving the first request transmitted by the terminal device, the first AMF first determines whether the terminal device supports TN access based on the first indication information in the first request; and if the terminal device supports TN access and the location indicated by the first location information is within the coverage of TN, the first AMF instructs the terminal device to report the location information of TN. Then, when receiving the second location information of the terminal device, the first AMF determines the NTN registration result based on the second location information and then transmits the NTN registration result to the terminal device. Thus, determining the NTN registration result based on the second location information determined by TN ensures that the NTN registration result is determined based on reliable location information, improving the reliability and security of NTN.

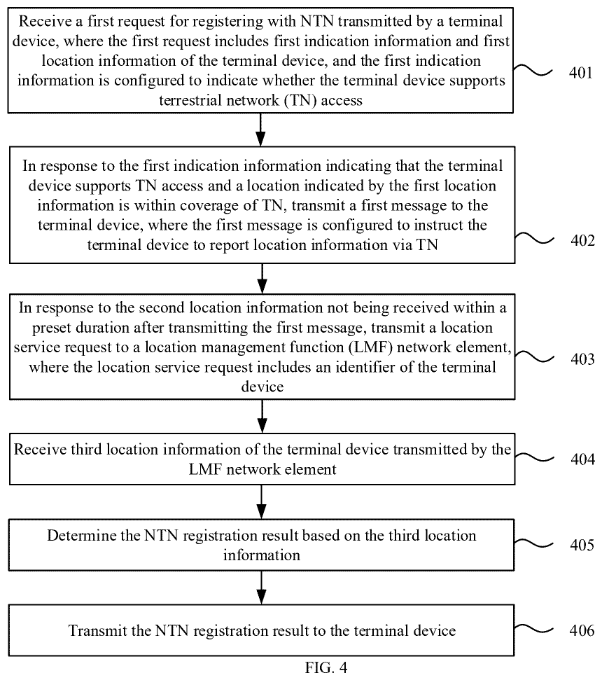

Referring to FIG. 4, FIG. 4 is a flowchart of another method for accessing a non-terrestrial network provided in the embodiments of the present disclosure. The method provided in this embodiment can be performed by a first AMF. As shown in FIG. 4, the method may include but is not limited to the following steps 401 to 406.

In step 401, a first request for registering with NTN transmitted by a terminal device is received, where the first request includes first indication information and first location information of the terminal device, and the first indication information is configured to indicate whether the terminal device supports terrestrial network (TN) access.

In step 402, in response to the first indication information indicating that the terminal device supports TN access and a location indicated by the first location information is within coverage of TN, a first message is transmitted to the terminal device, where the first message is configured to instruct the terminal device to report location information via TN.

Where the specific implementation of steps 401 and 402 can refer to the detailed description of any embodiment of the present disclosure, and will not be repeated here.

In step 403, in response to the second location information not being received within a preset duration after transmitting the first message, a location service request is transmitted to a location management function (LMF) network element, where the location service request includes an identifier of the terminal device.

In some embodiments, the first AMF can determine the preset duration according to the protocol agreement; alternatively, the preset duration can be determined based on the preset information, which is not limited in the present disclosure.

In the present disclosure, when the first AMF determines that the terminal device supports TN access and that the location where the terminal device is located has TN coverage, the first AMF can trigger the terminal device to verify the first location information through TN. However, in the case where the first location information cannot accurately represent the true location of the terminal device, such as when the first location information is within the coverage of TN but the actual location of the terminal device is not within the coverage of TN, the terminal device cannot access TN after receiving the first message and verify the first location information via TN. Therefore, in the present disclosure, the first AMF can start timing after transmitting the first message to the terminal device. When the preset duration is reached and the second location information is not received, the first AMF can determine that the first location information cannot currently be verified via TN. Therefore, a location service request can be transmitted to the LMF to request the LMF to locate the terminal device through location service (LCS).

In some embodiments, the first AMF can transmit a location service request to the LMF through a location determination request, such as transmitting a location service request to the LMF through Nlmf_Location_Determine Location service, which is not limited in the present disclosure.

In step 404, third location information of the terminal device transmitted by the LMF network element is received.

Where the third location information is the location information of the terminal device determined by the LMF network element by calling the LCS service.

In step 405, the NTN registration result is determined based on the third location information.

In step 406, the NTN registration result is transmitted to the terminal device.

Where the specific implementation of steps 405 and 406 can refer to the detailed description of any embodiment of the present disclosure, and will not be repeated here.

In some embodiments, after receiving the third location information transmitted by LMF, the first AMF can directly determine whether the country or region to which the third location information belongs is within the coverage where the PLMN selected by the terminal device allows the terminal device to operate. If yes, it can be determined that the NTN registration is successful; otherwise, it can be determined that the NTN registration has failed.

Alternatively, after receiving the third location information, the first AMF can compare the third location information with the first location information. If the two are the same, it can be determined that the first location information is reliable. Then, it can be determined whether the country or region where the first location information is located is within the coverage where the PLMN selected by the terminal device allows the terminal device to operate. If yes, it can be determined that the NTN registration is successful; otherwise, it can be determined that the NTN registration has failed. Alternatively, if the first location information is different from the third location information, the first AMF can consider that the third location information can reliably represent the actual location of the terminal device, and determine whether the country or region where the third location information is located is within the coverage where the PLMN selected by the terminal device allows the terminal device to operate. If yes, it can be determined that the NTN registration is successful; otherwise, it can be determined that the NTN registration has failed.

In the present disclosure, after receiving the first request transmitted by the terminal device, the first AMF first determines whether the terminal device supports TN access based on the first indication information in the first request; and if the terminal device supports TN access and the location indicated by the first location information is within the coverage of TN, the first AMF instructs the terminal device to report the location information of TN. If the second location information of the terminal device is not received within the preset duration, the first AMF transmits a location service request to LMF again. Then, when receiving the third location information transmitted by LMF, the first AMF determines the NTN registration result based on the third location information and transmits the NTN registration result to the terminal device. Thus, determining the NTN registration result based on the third location information determined by LMF ensures that the NTN registration result is determined based on reliable location information, improving the reliability and security of NTN.

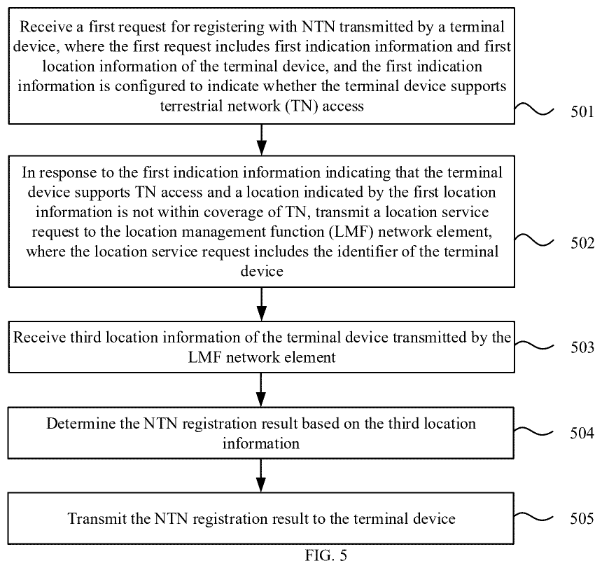

Referring to FIG. 5, FIG. 5 is a flowchart of another method for accessing a non-terrestrial network provided in the embodiments of the present disclosure. The method is performed by the first AMF. As shown in FIG. 5, the method may include but is not limited to the following steps 501 to 505.

In step 501, a first request for registering with NTN transmitted by a terminal device is received, where the first request includes first indication information and first location information of the terminal device, and the first indication information is configured to indicate whether the terminal device supports terrestrial network (TN) access.

In step 502, in response to the first indication information indicating that the terminal device supports TN access and a location indicated by the first location information is not within coverage of TN, a location service request is transmitted to the location management function (LMF) network element, where the location service request includes the identifier of the terminal device.

In the present disclosure, if the first LMF determines that the terminal device supports TN access based on the first indication information, but the first location information is not within the coverage of TN, which means that the terminal device cannot currently locate via TN, then the LMF can be triggered to locate the terminal device through LCS service.

In some embodiments, the first LMF can also transmit a location service request to the LMF network element when the first indication information indicates that the terminal device does not support TN access, where the location service request includes the identifier of the terminal device.

In step 503, third location information of the terminal device transmitted by the LMF network element is received.

In step 504, the NTN registration result is determined based on the third location information.

In step 505, the NTN registration result is transmitted to the terminal device.

Where the specific implementation of steps 503 and 505 can refer to the detailed description of any embodiment of the present disclosure, and will not be repeated here.

In the present disclosure, after receiving the first request transmitted by the terminal device, the first AMF first determines whether the terminal device supports TN access based on the first indication information in the first request; and if the terminal device supports TN access but the location indicated by the first location information is not within the coverage of TN, the LMF can be triggered to locate the terminal device. Then, when receiving the third location information transmitted by the LMF, the first AMF determines the NTN registration result based on the third location information and then transmits the NTN registration result to the terminal device. Thus, determining the NTN registration result based on the third location information determined by LMF ensures that the NTN registration result is determined based on reliable location information, improving the reliability and security of NTN.

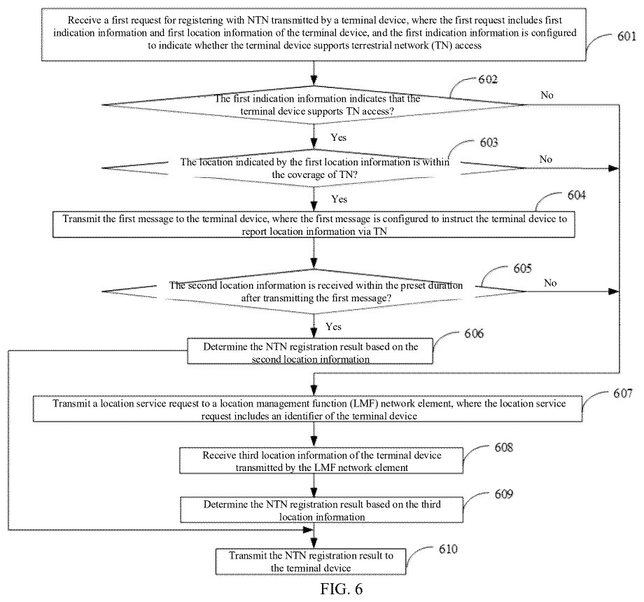

Referring to FIG. 6, FIG. 6 is a flowchart of another method for accessing a non-terrestrial network provided in the embodiments of the present disclosure. The method is performed by the first AMF. As shown in FIG. 6, the method may include but is not limited to the following steps 601 to 610.

In step 601, a first request for registering with NTN transmitted by a terminal device is received, where the first request includes first indication information and first location information of the terminal device, and the first indication information is configured to indicate whether the terminal device supports terrestrial network (TN) access.

In step 602, if the first indication information indicates that the terminal device supports TN access, proceed to step 603; otherwise, proceed to step 607.

In step 603, if the location indicated by the first location information is within the coverage of TN, proceed to step 604; otherwise, proceed to step 607.

In step 604, the first message is transmitted to the terminal device, where the first message is configured to instruct the terminal device to report location information via TN.

In step 605, if the second location information is received within the preset duration after transmitting the first message, proceed to step 606; otherwise, proceed to step 607.

In step 606, the NTN registration result is determined based on the second location information.

In step 607, a location service request is transmitted to a location management function (LMF) network element, where the location service request includes an identifier of the terminal device.

In step 608, third location information of the terminal device transmitted by the LMF network element is received.

In step 609, the NTN registration result is determined based on the third location information.

In step 610, the NTN registration result is transmitted to the terminal device.

Where the specific implementation of the above steps can refer to the detailed description of any embodiment of the present disclosure, and will not be repeated here.

In the present disclosure, after receiving the first request transmitted by the terminal device, the first AMF first determines whether the terminal device supports TN access. If the terminal device supports, the terminal device can be triggered to report location information via TN; and otherwise, the LMF can be triggered to locate the terminal device and determine the NTN registration result based on the obtained new location information of the terminal device, and transmits the registration result to the terminal device. Thus, it is ensured that the NTN registration result is determined based on reliable location information, improving the reliability and security of the NTN.

Referring to FIG. 7A, FIG. 7A is a flowchart of another method for accessing a non-terrestrial network provided in the embodiments of the present disclosure. The method is performed by the terminal device. As shown in FIG. 7A, the method may include but is not limited to the following steps 71 to 72.

In step 71, a first request for registering with a non-terrestrial network (NTN) is transmitted to a first access and mobility management function (AMF) network element, where the first request includes the indication information and first location information of the terminal device, and the first indication information is configured to indicate whether the terminal device supports terrestrial network (TN) access.

Where the implementation of the first request, first location information, and first indication can refer to the detailed description of any embodiment in the present disclosure, and will not be repeated here.

In some embodiments, the first AMF is any one AMF selected by the terminal device during network access.

In the present disclosure, when the terminal device needs to access the network via satellite, the terminal device can transmit a first request to the first AMF and carry the first indication information indicating whether the terminal device supports TN access in the first request, such that the first AMF can determine how to verify the first location information based on the first indication information, to determine whether the current location of the terminal device allows the PLMN selected by the terminal device to operate.

In some embodiments, the first request can be first transmitted by the terminal device to the NTN access network device, and then forwarded by the NTN access network device to the first AMF. The present disclosure does not limit this.

In step 72, an NTN registration result transmitted by the first AMF network element is received.

In some embodiments, the terminal device can receive the NTN registration result transmitted by the first AMF through a registration response message.

In some embodiments, the terminal device can determine the NTN registration result based on a field in the registration response message. Different values of this field indicate different registration results.

In the present disclosure, after receiving the NTN registration result, the terminal device can determine whether the terminal device is currently allowed to communicate based on the selected PLMN. If allowed, the terminal device can use the selected PLMN for communication. In the present disclosure, when the terminal device accesses the network through satellite, it can first transmit a first request containing first indication information indicating whether the terminal device supports TN access to the first AMF, such that the first AMF can select an appropriate method to verify the first location information based on whether the terminal device supports TN access. Thus, it is ensured that the NTN registration result is determined based on reliable location information, improving the reliability and security of the NTN.

Referring to FIG. 7B, FIG. 7B is a flowchart of another method for accessing a non-terrestrial network provided in the embodiments of the present disclosure. The method is performed by the terminal device. As shown in FIG. 7B, the method may include but is not limited to the following steps 73 to 76.

In step 73, a first request for registering with a non-terrestrial network (NTN) is transmitted to a first access and mobility management function (AMF) network element, where the first request includes the indication information and first location information of the terminal device, and the first indication information is configured to indicate whether the terminal device supports terrestrial network (TN) access.

Where the specific implementation of step 73 can refer to the detailed description of any embodiment of the present disclosure, and will not be repeated here.

In step 74, the first message transmitted by the first AMF network element is received, where the first message is configured to instruct the terminal device to report location information via TN.

In step 75, a second request for registering with TN is transmitted to a second AMF network element, where the second request includes second indication information and second location information determined via TN, where the second indication information is configured to indicate verification of the location information via TN.

In some embodiments, the second AMF network element and the first AMF network element may be the same network element or different network elements, which is not limited in the present disclosure.

That is, the AMF selected by the terminal device during NTN access may be the same as or different from the AMF selected by the terminal during TN access.

In the present disclosure, if the terminal device supports TN access, the first AMF can transmit a first message to the terminal device to instruct the terminal device to report location information via TN, such that the first AMF can obtain the location determined by the terminal device via TN, and then determine the NTN registration result based on reliable location information.

In some embodiments, if the second AMF is the same as the first AMF, the terminal device can directly transmit its second location information determined via TN to the first AMF through the second request, such that the first AMF can directly determine the NTN registration result based on the second location information.

Alternatively, if the second AMF is different from the first AMF, the terminal device can transmit the second location information to the second AMF through a second request. The second AMF can then synchronize the second location information to the first AMF via UDM, such that the first AMF can determine the NTN registration result based on the second location information.

In addition, since the purpose of the terminal device transmitting the second request is not for accessing TN, but to verify the location of NTN through TN, the second request may further include second indication information. The implementation of the second indication information can refer to the detailed description of any embodiment in the present disclosure, and will not be repeated here.

In some embodiments, after the terminal device transmits the second request, the second AMF can synchronize the second location information with UDM and return a request response to the terminal device to notify the terminal device that location information verification has been completed, which is not limited in the present disclosure.

In step 76, an NTN registration result transmitted by the first AMF network element is received.

In the present disclosure, when the terminal device accesses the network via satellite, the terminal device can first transmit a first request containing the first indication information indicating whether the terminal device supports TN access to the first AMF. After receiving the first message returned by the first AMF, the terminal device can then transmit a second request to the second AMF to request verification of the NTN location via TN, such that the first AMF can determine the NTN registration result based on the verified location information. Thus, it is ensured that the NTN registration result is determined based on reliable location information, improving the reliability and security of the NTN.

Referring to FIG. 7C, FIG. 7C is a schematic interaction diagram of a method for accessing a non-terrestrial network provided in the embodiments of the present disclosure. As shown in FIG. 7C, this embodiment takes the example of the terminal device supporting TN access, and the location indicated by the first location information is within the coverage of TN. In addition, in this embodiment, it is assumed that the AMFs for the first and second requests transmitted by the receiving terminal device are different. This method can include but is not limited to the following steps 701 to 710.

In step 701, the first AMF receives the first request for registering with the NTN transmitted by the terminal device, where the first request includes the first location information and the first indication information.

In step 702, the first AMF transmits the first location information and the identifier of the terminal device to the UDM.

In step 703, the first AMF transmits a first message to the terminal device, where the first message is configured to instruct the terminal device to report location information via TN.

Where steps 702 and 703 can be performed simultaneously, or step 703 can be performed first and then step 702, which is not limited in the present disclosure.

In step 704, the terminal device transmits a second request for registering with TN to the second AMF, where the second request includes the second indication information and the second location information determined through TN.

In step 705, the second AMF transmits the second location information and second indication information to the UDM.

In step 706, UDM transmits the second location information to the first AMF.

In step 707, the first AMF determines the NTN registration result based on the second location information.

In step 708, the NTN registration result is returned to the terminal device.

In step 709, UDM returns a rejection message to the second AMF.

In some embodiments, the rejection message may include a reason for rejection, such as NTN location information verification, etc, which is not limited in the present disclosure.

Where steps 706 and 709 mentioned above can be performed simultaneously, or step 709 can be performed first and then step 706, which is not limited in the present disclosure.

In step 710, the second AMF returns an NTN location verification completion message to the terminal device.

In the present disclosure, after receiving the first request transmitted by the terminal device, the first AMF first transmits the first location information and the terminal device identifier to the UDM, and then triggers the terminal device to report the location information via TN. After that, the terminal device can report the location via TN. After receiving the second location information returned by the UDM, the first AMF can determine the NTN registration result based on the second location information and transmit the registration result to the terminal device. Thus, it is ensured that the NTN registration result is determined based on reliable location information, improving the reliability and security of the NTN.

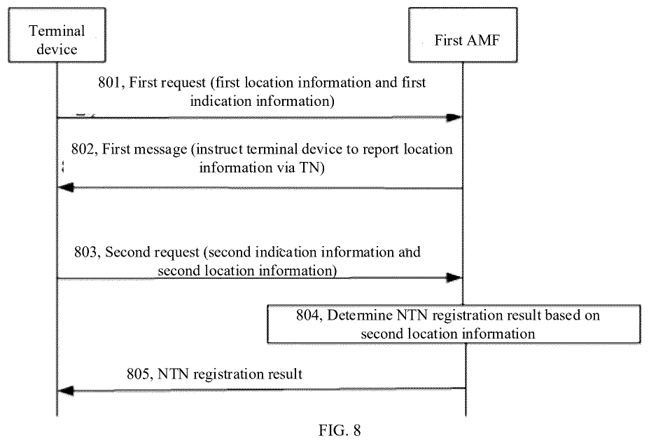

Referring to FIG. 8, FIG. 8 is a schematic interaction diagram of a method for accessing a non-terrestrial network provided in the embodiments of the present disclosure. As shown in FIG. 8, this embodiment takes the example of the terminal device supporting TN access, and the location indicated by the first location information is within the coverage of TN. In addition, in this embodiment, it is assumed that the AMFs for the first and second requests transmitted by the receiving terminal device are the same. This method can include but is not limited to the following steps 801 to 805.

In step 801, the first AMF receives the first request for registering with the NTN transmitted by the terminal device, where the first request includes the first location information and the first indication information.

In step 802, the first AMF transmits a first message to the terminal device, where the first message is configured to instruct the terminal device to report location information via TN.

In step 803, the terminal device transmits a second request for registering with TN to the first AMF, where the second request includes second location information and second indication information.

In step 804, the first AMF determines the NTN registration result based on the second location information.

In step 805, the NTN registration result is returned to the terminal device.

In the present disclosure, after receiving the first request transmitted by the terminal device, the first AMF first triggers the terminal device to report location information via TN, and then the terminal device can report location information via TN. After receiving the second location information returned by the terminal device, the first AMF can determine the NTN registration result based on the second location information and transmit the registration result to the terminal device. Thus, it is ensured that the NTN registration result is determined based on reliable location information, improving the reliability and security of the NTN.

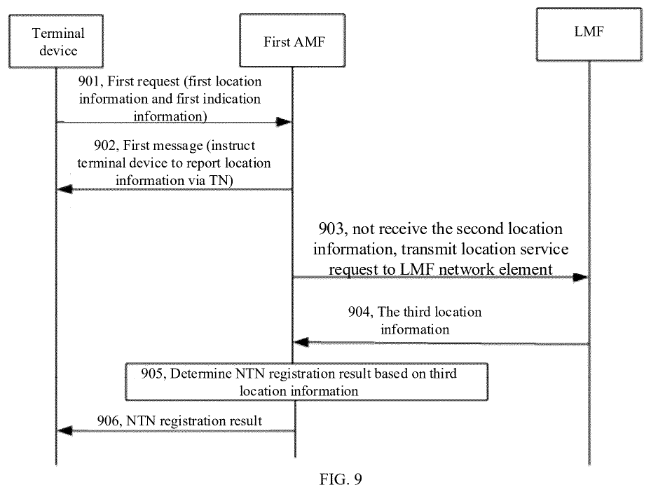

Referring to FIG. 9, FIG. 9 is a schematic interaction diagram of a method for accessing a non-terrestrial network provided in the embodiments of the present disclosure. As shown in FIG. 9, this embodiment takes the example of the terminal device supporting TN access, and the location indicated by the first location information is within the coverage of TN. In addition, in this embodiment, it is assumed that the AMFs for the first and second requests transmitted by the receiving terminal device are the same. This method can include but is not limited to the following steps 901 to 906.

In step 901, the first AMF receives the first request for registering with the NTN transmitted by the terminal device, where the first request includes the first location information and the first indication information.

In step 902, the first AMF transmits a first message to the terminal device, where the first message is configured to instruct the terminal device to report location information via TN.

In step 903, in response to the second location information not being received within a preset duration after transmitting the first message, the first AMF transmits a location service request to LMF network element, where the location service request includes an identifier of the terminal device.

In step 904, third location information of the terminal device transmitted by the LMF network element is received.

In step 905, the NTN registration result is determined based on the third location information.

In step 906, the NTN registration result is returned to the terminal device.

In the present disclosure, after receiving the first request transmitted by the terminal device, the first AMF first triggers the terminal device to report location information via TN, and then the terminal device can report location information via TN. If the first AMF does not receive the second location information returned by the terminal device within the preset duration, the LMF is triggered to locate the terminal device. After receiving the third location information returned by the LMF, the first AMF can determine the NTN registration result based on the third location information and transmit the registration result to the terminal device. Thus, it is ensured that the NTN registration result is determined based on reliable location information, improving the reliability and security of the NTN.

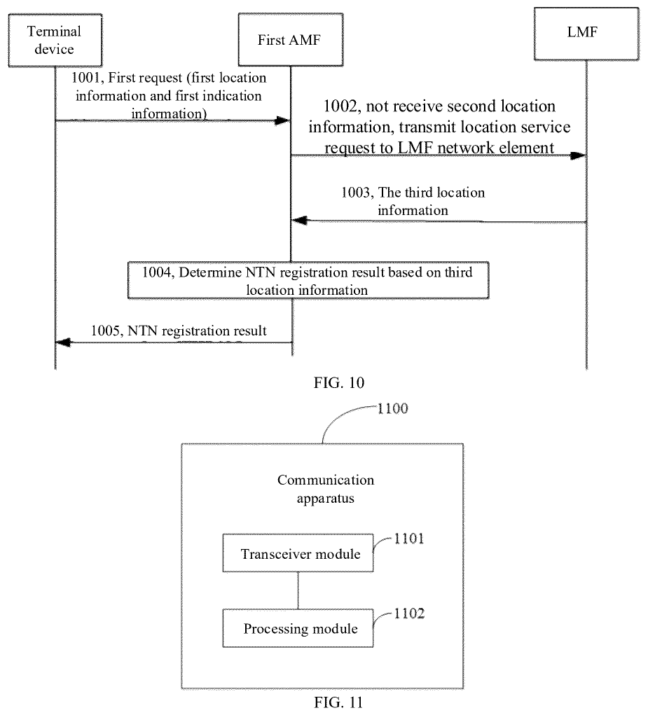

Referring to FIG. 10, FIG. 10 is a schematic interaction diagram of a method for accessing a non-terrestrial network provided in the embodiments of the present disclosure. As shown in FIG. 10, this embodiment takes the example of a terminal device supporting TN access, but the location indicated by the first location information is not within the coverage of TN, or the terminal device does not support TN access. The method may include but is not limited to the following steps 1001 to 1005.

In step 1001, the first AMF receives the first request for registering with the NTN transmitted by the terminal device, where the first request includes the first location information and the first indication information.

In step 1002, a location service request is transmitted to a location management function (LMF) network element, where the location service request includes an identifier of the terminal device.

In step 1003, third location information of the terminal device transmitted by the LMF network element is received.

In step 1004, the NTN registration result is determined based on the third location information.

In step 1005, the NTN registration result is returned to the terminal device.

In the present disclosure, after receiving the first request transmitted by the terminal device, the first AMF first triggers the LMF to locate the terminal device. Then, upon receiving the third location information returned by the LMF, the first AMF can determine the NTN registration result based on the third location information and transmit the registration result to the terminal device. Thus, it is ensured that the NTN registration result is determined based on reliable location information, improving the reliability and security of the NTN.

Referring to FIG. 11, FIG. 11 is a schematic structural diagram of a communication device provided in the embodiments of the present disclosure. The communication device 1100 shown in FIG. 9 may include a transceiver module 1101 and a processing module 1102. The transceiver module 1101 can include a transmitting module and/or a receiving module. The transmitting module is configured to achieve a transmitting function, the receiving module is configured to achieve a receiving function, and the transceiver module 1101 can achieve the transmitting and/or receiving functions.

It can be understood that communication device 1100 can be the first AMF, or a device within the first AMF, or a device that can be used in conjunction with the first AMF.

The communication device 1100 is on the first AMF side.

The transceiver module 1101 is configured to receive a first request for registering with a non-terrestrial network (NTN) transmitted by a terminal device, where the first request includes first indication information and first location information of the terminal device, and the first indication information of configured to indicate whether the terminal device supports terrestrial network (TN) access.

The processing module 1102 is configured to determine an NTN registration result.

The transceiver module 1101 is further configured to transmit the NTN registration result to the terminal device.

In some embodiments, the processing module 1102 is further configured to, in response to the first indication information indicating that the terminal device supports TN access and a location indicated by the first location information is within coverage of TN, transmit a first message to the terminal device, where the first message is configured to instruct the terminal device to report location information via TN.

The transceiver module 1101 is further used to receive second location information of the terminal device, where the second location information is determined via TN.

The processing module 1102 is further configured to determine the NTN registration result according to the second location information.

In some embodiments, the transceiver module 1101 is further configured to:
receive the second location information transmitted by a unified data management (UDM) network element, where the second location information is transmitted to the UDM by a second AMF, and the second AMF is configured to receive a second request for registering with TN transmitted by the terminal device; or
receive a second request for registering with TN transmitted by the terminal device;
where the second request includes the second location information and second indication information, where the second indication information is configured to indicate verification of the location information via TN.

In some embodiments, the transceiver module 1101 is further configured to:
transmit a second message to the UDM network element, where the second message includes the first location information and an identifier of the terminal device.

In some embodiments, the transceiver module 1101 is further configured to:
in response to not receiving the second location information within a preset duration after transmitting the first message, transmit a location service request to a location management function (LMF) network element, where the location service request includes an identifier of the terminal device;
receive third location information of the terminal device transmitted by the LMF network element; and
the processing module 1102 is further configured to determine the NTN registration result according to the third location information.

In some embodiments, the transceiver module 1101 is further configured to:
in response to the first indication information indicating that the terminal device supports TN access and a location indicated by the first location information is not within coverage of TN, transmit a location service request to the LMF network element, where the location service request includes the identifier of the terminal device;
receive third location information of the terminal device transmitted by the LMF network element; and
the processing module 1102 is further configured to determine the NTN registration result according to the third location information.

In some embodiments, the transceiver module 1101 is further configured to:
in response to the first indication information indicating that the terminal device does not support TN access, transmit a location service request to the LMF network element, where the location service request includes the identifier of the terminal device;
receive third location information of the terminal device transmitted by the LMF network element; and
the processing module 1102 is further configured to determine the NTN registration result according to the third location information.

In the present disclosure, after receiving the first request transmitted by the terminal device, the communication device first determines the NTN registration result based on the first location information and first indication information in the first request, and then transmits the NTN registration result to the terminal device. Thus, it is ensured that the NTN registration result is determined based on reliable location information, improving the reliability and security of the NTN.

In some embodiments, communication device 1100 can be a terminal device, or a device within a terminal device, or a device that can be used in conjunction with the terminal device.

The communication device 1100 is on the terminal device side.

The transceiver module 1101 is configured to transmit a first request for registering with a non-terrestrial network (NTN) to a first access and mobility management function (AMF) network element, where the first request includes first indication information and first location information of the terminal device, and the first indication information is configured to indicate whether the terminal device supports terrestrial network (TN) access.

The transceiver module 1101 is further configured to receive an NTN registration result transmitted by the first AMF network element.

In some embodiments, the transceiver module 1101 is further configured to:
receive a first message transmitted by the first AMF network element, where the first message is configured to instruct the terminal device to report location information via TN; and
transmit a second request for registering with TN to a second AMF network element, where the second request includes second indication information and second location information determined via TN, where the second indication information is configured to indicate verification of the location information via TN.

In the present disclosure, when the terminal device accesses the network through satellite, it can first transmit a first request containing first indication information indicating whether the terminal device supports TN access to the first AMF, such that the first AMF can select an appropriate method to verify the first location information based on whether the terminal device supports TN access. Thus, it is ensured that the NTN registration result is determined based on reliable location information, improving the reliability and security of the NTN.

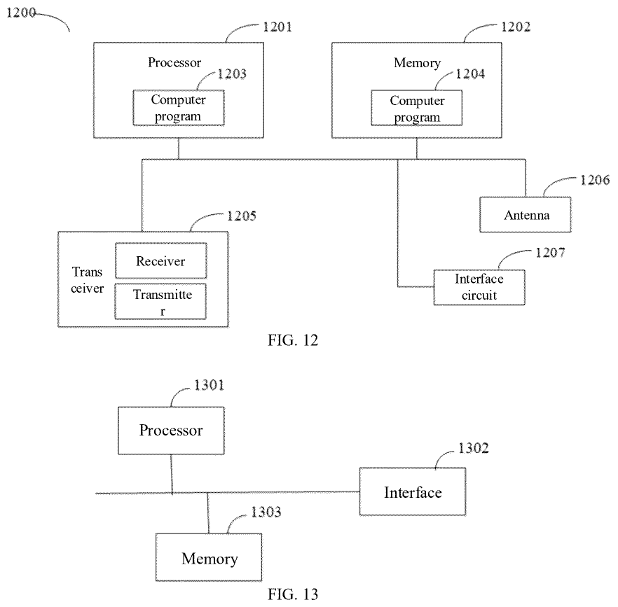

Referring to FIG. 12, FIG. 12 is a schematic structural diagram of another communication device provided in the embodiments of the present disclosure. The communication device 1200 can be the first AMF, or a chip, chip system, or processor that supports the first AMF to implement the above methods. Alternatively, the communication device 1200 can also be a terminal device, or a chip, chip system, or processor that supports the terminal device to implement the above methods. The device can be configured to implement the methods described in the above method embodiments, as described in the above method embodiments.

The communication device 1200 may include one or more processors 1201. The processor 1201 can be a general-purpose processor or a dedicated processor, etc. For example, the processor 181 can be a baseband processor or a central processing unit. The baseband processor can be used to process communication protocols and communication data, while the central processor can be used to control communication devices (such as base stations, baseband chips, terminal devices, terminal device chips, DU or CU, etc.), execute computer programs, and process computer program data.

In an embodiment, the communication device 1200 may further include one or more memories 1202, on which a computer program 1204 may be stored, and the processor 1201 may execute the computer program 1204 to enable the communication device 1200 to execute the method described in the above embodiments. In an embodiment, the memory 1202 may further store data. The communication device 1200 and memory 1202 can be set separately or integrated together.

In an embodiment, the communication device 1200 may also include a transceiver 1205 and an antenna 1206. The transceiver 1205 can be referred to as a transceiver unit, transceiver machine, or transceiver circuit, etc., used to achieve transceiver functions. The transceiver 1205 can include a receiving terminal and a transmitter, and the receiving terminal can be referred to as a receiving machine or a receiving circuit, etc., to achieve receiving functions. A transmitter can be referred to as a transmitting machine or a transmission circuit, etc., used to achieve transmission functions.

In an embodiment, the communication device 1200 may further include one or more interface circuits 1207. Interface circuit 1207 is configured to receive code instructions and transmit them to processor 1201. The processor 1201 runs the code instructions to cause the communication device 1200 to execute the method described in the above method embodiment.

The transceiver 1205 in the communication device 1200 can be configured to perform the transmission and reception steps in the above figures, and the processor 1201 can be configured to perform the processing steps in the above figures.

In an embodiment, the processor 1201 may include a transceiver for implementing reception and transmission functions. For example, the transceiver can be a transceiver circuit, an interface, or an interface circuit. The transceiver circuit, interface, or interface circuit used to achieve receiving and transmitting functions can be separate or integrated together. The above-mentioned transceiver circuit, interface or interface circuit can be used for reading and writing code/data, or the above-mentioned transceiver circuit, interface or interface circuit can be used for signal transmission or transmission.

In an embodiment, the processor 1201 may store a computer program 1203. The computer program 1203 runs on the processor 1201 to enable the communication device 1200 to execute the method described in the above embodiments. The computer program 1203 may be embedded in processor 1201, where the processor 1201 may be implemented by hardware.

In an embodiment, the communication device 1200 may include a circuit that can perform the functions of transmitting, receiving, or communicating as described in the aforementioned method embodiments. The processor and transceiver described in the present disclosure can be implemented on integrated circuits (ICs), analog ICs, RF integrated circuits (RFICs), mixed signal ICs, application specific integrated circuits (ASICs), printed circuit boards (PCBs), electronic devices, or the like. The processor and transceiver can also be manufactured using various IC process technologies, such as complementary metal oxide semiconductor (CMOS), nMetal oxide semiconductor (NMOS), positive channel metal oxide semiconductor (PMOS), bipolar junction transistor (BJT), bipolar CMOS (BiCMOS), silicon germanium (SiGe), or gallium arsenide (GaAs), etc.

The communication device described in the above embodiments may be a network device or an intelligent relay, but the scope of the communication device described in the present disclosure is not limited to this, and the structure of the communication device may not be limited by FIG. 12. The communication device can be an independent device or can be part of a larger device. For example, the communication device may be:
(1) Independent integrated circuit (IC), or a chip, or a chip system or a subsystem;
(2) A set of one or more ICs, which may optically further include a storage component for storing data or a computer program;
(3) ASICs, such as modems;
(4) Modules that can be embedded in other devices;
(5) Receiver, terminal device, intelligent terminal device, cellular phone, wireless device, handheld device, mobile unit, vehicle mounted device, network device, cloud device, or artificial intelligence device, etc;
(6) Others and so on.

In a case where the communication device is a chip or a chip system, it can be referred to the schematic structural diagram of a chip shown in FIG. 13. The chip shown in FIG. 13 includes a processor 1301 and an interface 1302. The number of processors 1301 can be one or more, and the number of interfaces 1302 can be multiple.

For the case where the chip is configured to implement the functions of the terminal device in the embodiments of the present disclosure.

In some embodiments, the chip also includes a memory 1303, which is configured to store necessary computer programs and data.

Those skilled in the art can also understand that the various illustrative logical blocks and steps listed in the embodiments of the present disclosure can be implemented through electronic hardware, computer software, or a combination of both. Whether such functionality is implemented through hardware or software depends on the specific application and overall system design requirements. Those skilled in the art may use various methods to implement the described functions for each specific application, but such implementation should not be understood as exceeding the scope of protection in the embodiments of the present disclosure.

The present disclosure further provides a readable storage medium on which instructions are stored, and when the instructions are executed by a computer, the functions of any one of the above method embodiments are implemented.

The present disclosure further provides a computer program product that implements the functions of any one of the above method embodiments when executed by a computer.

The above embodiments can be fully or partially implemented through software, hardware, firmware, or any combination thereof. When implemented using software, all or part of the steps can be implemented in the form of a computer program product. The computer program product includes one or more computer programs. When loading and executing the computer program on the computer, all or part of the processes or functions described in the embodiments of the present disclosure are generated. The computer can be a general-purpose computer, a specialized computer, a computer network, or other programmable devices. The computer program can be stored in a computer-readable storage medium or transmitted from one computer-readable storage medium to another. For example, the computer program can be transmitted from one website site, computer, server, or data center to another via wired (such as coaxial cable, fiber optic, digital subscriber line (DSL)) or wireless (such as infrared, wireless, microwave, etc.) manners. The computer-readable storage medium can be any available medium that the computer can access, or a data storage device such as a server, data center, etc. that integrates one or more available media. The available medium can be a magnetic medium (such as floppy disk, hard disk, magnetic tape), optical medium (such as high-density digital video disc (DVD)), or semiconductor medium (such as solid state disk (SSD)), etc.

Those skilled in the art can understand that the first, second, and other numerical numbers involved in the present disclosure are only for the convenience of description and differentiation, and are not used to limit the scope of the embodiments of the present disclosure, and also do not indicate sequential ordering.

“At least one” in the present disclosure can also be described as one or more, and multiple can be two, three, four, or more, without limitation in the present disclosure. In embodiments of the present disclosure, for a technical feature, the technical features described in “first,” “second,” “third,” “A,” “B,” “C,” and “D” are distinguished, and there is no sequential ordering or magnitude ordering between the technical features described in “first,” “second,” “third,” “A,” “B,” “C,” and “D.”

The corresponding relationships shown in each table in the present disclosure can be configured or predefined. The values of the information in each table are only examples and can be configured to other values, which is not limited in the present disclosure. When configuring the correspondence between information and various parameters, it is not necessary to configure all the correspondence shown in each table. For example, in the table of the present disclosure, the corresponding relationships shown in certain rows may not be configured. For example, appropriate deformation adjustments can be made according to the above table, such as splitting, merging, etc. The names of the parameters shown in the titles of the above tables can also use other names that can be understood by the communication device, and the values or representations of their parameters can also be understood by other values or representations that can be understood by the communication device. When implementing the above tables, other data structures can also be used, such as arrays, queues, containers, stacks, linear tables, pointers, linked lists, trees, graphs, structures, classes, heaps, hash tables, or hash tables.

The predefined terms in the present disclosure can be understood as defined, defined in advance, stored, pre-stored, pre-negotiated, pre-configured, solidified, or pre-fired.

Those skilled in the art can realize that the units and algorithm steps of each example described in the embodiments of the present disclosure can be implemented in electronic hardware, or a combination of computer software and electronic hardware. Whether these functions are executed in hardware or software depends on the specific application and design constraints of the technical solution. Those skilled in the art may use different methods to implement the described functions for each specific application, but such implementation should not be considered beyond the scope of the present disclosure.

Those skilled in the art can clearly understand that for the convenience and brevity of description, the specific working process of the above-described system, apparatus and unit can refer to the corresponding process in the foregoing method embodiments, which will not be repeated here.

The foregoing description is merely a specific embodiment of the present disclosure, but the scope of protection of the present disclosure is not limited thereto, and any variation or replacement readily conceivable by a person skilled in the art within the technical scope disclosed in the present disclosure should belong to the scope of protection of the present disclosure. Therefore, the scope of protection of the present disclosure should be based on the scope of protection of said claims.

1. A method for accessing a non-terrestrial network, performed by a first access and mobility management function (AMF) network element, comprising:
receiving a first request for registering with a non-terrestrial network (NTN) transmitted by a terminal device, wherein the first request comprises first indication information and first location information of the terminal device, and the first indication information is configured to indicate whether the terminal device supports terrestrial network (TN) access;
determining an NTN registration result; and
transmitting the NTN registration result to the terminal device.

2. The method according to claim 1, wherein determining the NTN registration result comprises:
in response to the first indication information indicating that the terminal device supports TN access and a location indicated by the first location information is within coverage of TN, transmitting a first message to the terminal device, wherein the first message is configured to instruct the terminal device to report location information via TN;
receiving second location information of the terminal device, wherein the second location information is determined via TN; and
determining the NTN registration result according to the second location information.

3. The method according to claim 2, wherein receiving the second location information of the terminal device comprises:
receiving the second location information transmitted by a unified data management (UDM) network element, wherein the second location information is transmitted to the UDM by a second AMF, and the second AMF is configured to receive a second request for registering with TN transmitted by the terminal device; or
receiving the second request for registering with TN transmitted by the terminal device;
wherein the second request comprises the second location information and second indication information, wherein the second indication information is configured to indicate verification of location information via TN.

4. The method according to claim 3, wherein before receiving the second location information transmitted by the UDM network element, the method further comprises:
transmitting a second message to the UDM network element, wherein the second message comprises the first location information and an identifier of the terminal device.

5. The method according to claim 2, further comprising:
in response to not receiving the second location information within a preset duration after transmitting the first message, transmitting a location service request to a location management function (LMF) network element, wherein the location service request comprises an identifier of the terminal device;
receiving third location information of the terminal device transmitted by the LMF network element; and
determining the NTN registration result according to the third location information.

6. The method according to claim 1, wherein determining the NTN registration result comprises:
in response to the first indication information indicating that the terminal device supports TN access and a location indicated by the first location information is not within coverage of TN, transmitting a location service request a location management function (LMF) network element, wherein the location service request comprises an identifier of the terminal device;
receiving third location information of the terminal device transmitted by the LMF network element; and
determining the NTN registration result according to the third location information.

7. The method according to claim 1, wherein determining the NTN registration result comprises:
in response to the first indication information indicating that the terminal device does not support TN access, transmitting a location service request to a location management function (LMF) network element, wherein the location service request comprises the an identifier of the terminal device;
receiving third location information of the terminal device transmitted by the LMF network element; and
determining the NTN registration result according to the third location information.

8. A method for accessing a non-terrestrial network, performed by a terminal device, comprising:
transmitting a first request for registering with a non-terrestrial network (NTN) to a first access and mobility management function (AMF) network element, wherein the first request comprises first indication information and first location information of the terminal device, and the first indication information is configured to indicate whether the terminal device supports terrestrial network (TN) access; and
receiving an NTN registration result transmitted by the first AMF network element.

9. The method according to claim 8, wherein after transmitting the first request for registering with NTN to the AMF network element, the method further comprises:
receiving a first message transmitted by the first AMF network element, wherein the first message is configured to instruct the terminal device to report location information via TN; and
transmitting a second request for registering with TN to a second AMF network element, wherein the second request comprises second indication information and second location information determined via TN, wherein the second indication information is configured to indicate verification of location information via TN.

10.-11. (canceled)

12. A communication system, comprising:
an AMF; and
the terminal device, wherein the AMF is configured to perform the method according to claim 1.

13. A communication device, comprising one or more processors and one or more memories, wherein a computer program is stored in the one or more memories, and the one or more processors execute the computer program stored in the one or more memories to cause the communication device to act as the AMF network element and perform the method according to claim 1.

14. A non-transitory computer-readable storage medium storing instructions, the instructions when executed by a processor of the AMF network element cause the AMF network element to perform method according to claim 1.

15. A communication device, comprising one or more processors and one or more memories, wherein a computer program is stored in the one or more memories, and the one or more processors execute the computer program stored in the one or more memories to cause the communication device to act as the terminal device and perform the method according to claim 8.

16. A computer-readable storage medium storing instructions, the instructions when executed by a processor of the terminal device, cause the terminal device to perform the method according to claim 8.
